(19) United States
(12) Patent Application Publication
(10) Pub. No.: US 2014/0282209 A1
(43) Pub. Date: Sep. 18, 2014

(54) METHOD FOR ACTIVATING AN APPLICATION BAR

(71) Applicant: Logitech Europe S.A., Lausanne (CH)

(72) Inventors: Nestor Lopez Casado, Preverenges (CH); Laurent Mealares, St-Sulpice (CH); Aidan Kehoe, Cork (IE)

(73) Assignee: Logitech Europe S.A., Lausanne (CH)

(21) Appl. No.: 14/216,764

(22) Filed: Mar. 17, 2014

Related U.S. Application Data
(60) Provisional application No. 61/802,200, filed on Mar. 15, 2013.

(51) Int. Cl. G06F 3/0482; G06F 3/0484; G06F 3/0487; G06F 3/0481

(52) U.S. Cl. CPC G06F 3/0482; G06F 3/04812; G06F 3/04817; G06F 3/04842; G06F 3/0487
USPC 715/779

(57) ABSTRACT

Embodiments of the present invention provide an input device comprising a processor, a displacement sensor coupled to the processor and a control button coupled to the processor. The displacement sensor is controlled by the processor and configured to detect movement of the input device relative to a surface. The control button is configured to open a first side panel and a second side panel on a virtual desktop of an operating system. The first and second side panel are configured to be opened when the control button is pressed and the input device is moved in a direction of the particular side panel. The first side panel is populated with a first set of one or more selectable icons for launching executable files, and the second side panel is populated with a second set of one or more selectable icons for moving currently running applications to a virtual desktop foreground.

### CROSS-REFERENCES TO RELATED APPLICATIONS

This application claims priority to U.S. Provisional Patent Application No. 61/802,200, filed Mar. 15, 2013, the entire contents of which are herein incorporated by reference in its entirety for all purposes.

### BACKGROUND

The virtual desktop has evolved over the years and more improvements in utility and functionality continue to be made. Drop down menus and clickable icons have been a mainstay in many contemporary virtual desktop environments. However, modern desktop designs have incorporated new techniques to add more selectable options without sacrificing valuable desktop real estate. For example, keyboard hotkeys can be used to cycle between active applications, fade-in and fade-out popular applications such as a clock, calendar, and calculator, without permanently placing them on the desktop environment.

Some modern virtual desktops incorporate temporary sidebars that “pop out” of a side of the desktop and typically include applications that can be selected by a user. Sidebars can be advantageous as they effectively add additional desktop real estate without requiring any permanent space. Windows 8™ incorporates one example of the use of sidebars. Specifically, a user can activate a sidebar by touching or moving a mouse pointer or cursor to the corner of the screen. However, activating the edge from the hot corner with the mouse pointer can be cumbersome and inefficient, especially with regular use.

### BRIEF SUMMARY

Embodiments of the present invention relate generally to performing control functions on a virtual desktop with an input device. More specifically, embodiments relate to activating normally touch-activated application bars on a touch-activated virtual desktop and selecting an application with an input device.

Embodiments of the present invention provide an input device including a processor, a displacement sensor coupled to the processor and configured to detect movement of the input device relative to a surface, and a control button coupled to and controlled by the processor, where the control button configured to open a first side panel on a virtual desktop of an operating system. In some embodiments, the input device is further configured to open a second side panel on the virtual desktop, where the first side panel is opened when the control button is pressed, and the second side panel is opened when the control button is pressed and the input device is moved in the direction of the second side panel.

In further embodiments, the input device is further configured to open a second side panel on the virtual desktop, where the first side panel is opened when the control button is pressed and the input device is moved in a direction of the first side panel, and the second side panel is opened when the control button is pressed and the input device is moved in a direction of the second side panel. In some implementations, the first side panel is populated with a first set of one or more selectable icons for launching an executable files, and the second side panel is populated with a second set of one or more selectable icons for moving currently running applications to a foreground on the virtual desktop.

In certain embodiments, the input device is further configured to open a third side panel and a fourth side panel on the virtual desktop. The third side panel is opened when the control button is pressed and the input device is moved in a direction of the third side panel, and the fourth side panel is opened when the control button is pressed and the input device is moved in a direction of the fourth side panel. Some embodiments only have sidebars on the left/right, on the top/bottom, or any combination thereof. The sidebar functionality can be referred to as “edge controls,” “edge menus,” and the like, by virtue of one aspect of triggering the sidebar by moving a cursor or control icon to a corner (“hot corner”) of a screen, or by opening a sidebar by the control button, input device movement detection, or combinations thereof.

In further embodiments, the input device is further configured to control a cursor on the virtual desktop, where the control button is configured to open the first side panel on the virtual desktop when the control button is pressed and held, and each of the selectable icons is operable to be selected in response to the control button being released when the cursor is placed over the particular selectable icon. In some cases, each of the selectable icons is operable to be selected in response to the control button being pressed when the cursor is placed over the particular selectable icon.

In some embodiments, the first side panel of the input device is configured to close and the second side panel is configured to open in response to the control button still being pressed and the input device being moved in the direction of the second side panel by a predetermined displacement, and wherein the first side panel is configured to close and the second side panel is configured to open in response to the control button still being pressed and the input device being moved in the direction of the second side panel by the predetermined displacement. The predetermined displacement can be any suitable metric including a physical distance, a number of pixels, or other suitable metric for measuring displacement.

In certain embodiments, the input device further includes an input button, where the first and second side panels are closed when the input button or the control button are pressed in areas outside of the first or second side panels. The control button can be implemented in any suitable form including, but not limited to, mechanical, piezo-electric, capacitive, resistive, or touch sensor based button.

In further embodiments, a method includes receiving a first input signal indicating a button press on an input device, receiving a second input signal corresponding to a movement of a cursor on a virtual desktop and sending a command to open a first side panel on the virtual desktop in response to receiving the first input signal and the second input signal when the second input signal indicates cursor movement in the direction of the first side panel. The cursor can be controlled by the input device. The method further includes sending a command to open a second side panel on the virtual desktop in response to receiving the first input signal and the second input signal when the second input signal indicates cursor movement in the direction of the second side panel.

In certain embodiments, the method further includes sending a command to open a third side panel on the virtual desktop in response to receiving the first input signal and the second input signal when the second input signal indicates cursor movement in the direction of the third side panel, and sending a command to open a fourth side panel on the virtual desktop in response to receiving the first input signal and the second input signal when the second input signal indicates cursor movement in the direction of the fourth side panel.

In some embodiments, the first side panel is populated with a first set of one or more selectable icons for launching executable files, and the second side panel is populated with a second set of one or more selectable icons for moving currently running applications to a foreground on the virtual desktop.

In certain embodiments, the method further includes receiving the second input signal indicating movement and positioning of the cursor over a selectable icon, receiving the first input signal indicating a button press, and selecting the selectable icon that the cursor is positioned over.

In further embodiments, a system includes one or more processors and one or more non-transitory computer-readable storage mediums containing instructions configured to cause the one or more processors to perform operations including receiving a first input signal indicating a button press on an input device, receiving a second input signal corresponding to a movement of a cursor on a virtual desktop, where the cursor is controlled by the input device; and sending a command to open a first side panel on the virtual desktop in response to receiving the first input signal and the second input signal when the second input signal indicates cursor movement in the direction of the first side panel.

In some embodiments, the instructions are further configured to cause the one or more processors to perform operations including sending a command to open a second side panel on the virtual desktop in response to receiving the first input signal and the second input signal when the second input signal indicates cursor movement in the direction of the second side panel. In some implementations, the instructions can include sending a command to open a third side panel on the virtual desktop in response to receiving the first input signal and the second input signal when the second input signal indicates cursor movement in the direction of the third side panel, and sending a command to open a fourth side panel on the virtual desktop in response to receiving the first input signal and the second input signal when the second input signal indicates cursor movement in the direction of the fourth side panel.

In certain embodiments, the first side panel can be populated with a first set of one or more selectable icons for launching executable files, and the second side panel can be populated with a second set of one or more selectable icons for moving currently running applications to a foreground on the virtual desktop.

In further embodiments, the instructions are further configured to cause the one or more processors to perform operations including receiving the second input signal indicating movement and positioning of the cursor over a selectable icon, receiving the first input signal indicating a button press, selecting the selectable icon that the cursor is positioned over.

According to certain embodiments, a method of inputting a command on a virtual desktop includes receiving a button press command on an input device, receiving a movement command on the input device indicating a first or second direction, opening an icon selection bar including one or more executable applications in response to receiving a button press command and an indication of movement in the first direction, and opening an application selection bar including one or more currently running applications in response to receiving a button press command and an indication of movement in the second direction.

In some embodiments, pressing the control button and moving right, for example, opens a charms bar. Releasing the button while a cursor is over one of the charms will select that charm. Similarly, pressing the control button and moving left, for example, opens an applications bar (displaying currently open applications). Releasing the button while a cursor is over one of the applications will maximize that application (select that application and bring to foreground). If the button is released but the cursor is not located over either of the charms or applications bars, then the open bar closes and no action is taken.

In some aspects, a button press and movement causes the firmware on the operating system to execute an open charms command or open applications bar command, which can be independent of position. For example, with the cursor near the right side of the screen, pressing the button and moving left will still open the applications bar, according to certain embodiments. In some cases, the OS decides how to handle the press and release depending on the position of the cursor on the display.

Some embodiments may implement a snapping feature to quickly shuttle a cursor from a current position to the location of the charm or application bar. For example, if a cursor was located at the left lower quadrant of a display and a user pressed and held the charms button and moved slight to the right, the charms bar would appear. If the user, with the button still pressed, started moving the cursor to the right, the cursor can “snap” to the charm bar so that the user does not have to move the cursor over the entire distance.

In some embodiments, movement thresholds may be used to prevent a user from inadvertently closing a charm/application bar. For example, if a user opens the charms bar and accidentally moves the cursor outside of the bar (e.g., to the left), a threshold may be set such that the OS does not open the applications bar as a result of the left movement. The threshold can be determined or set based on the width of the charms/applications bar, the dots per inch (DPI) of the cursor movement, or other suitable method.

### BRIEF DESCRIPTION OF THE DRAWINGS

FIG. 1 is a simplified schematic diagram of a computer system, according to certain embodiments of the invention.

FIG. 2 is a simplified block diagram of a system configured to operate an input device, according to certain embodiments of the invention.

FIG. 3 is a simplified flow diagram illustrating a method of activating a sidebar on a virtual desktop, according to certain embodiments of the invention.

FIG. 4 is a simplified flow diagram illustrating a method of activating a sidebar on a virtual desktop, according to certain embodiments of the invention.

FIG. 5 is a simplified state chart illustrating operations including the activation of a sidebar on a virtual desktop, according to certain embodiments of the invention

FIG. 6 is a simplified state chart illustrating operations including the activation of a sidebar on a virtual desktop, according to certain embodiments of the invention

### DETAILED DESCRIPTION

Embodiments of the invention are generally related to systems, devices, and methods for operating a computer input device. Certain specific embodiments include systems and methods for activating one or more application bars on a virtual desktop environment and selecting content therein.

Embodiments of the present invention provide an input device comprising a processor, a displacement sensor coupled to the processor and a control button coupled to the processor. The displacement sensor is controlled by the processor and configured to detect movement of the input device relative to a surface. The control button is controlled by the processor and configured to activate an application bar or a executable file (“charms”) bar on a virtual desk top for an operating system with touch detection capabilities. In some implementations, pressing the control button and moving the input device in a first direction causes the charms bar to open, and pressing the control button and moving the input device in a second direction causes the application bar to open. In some aspects, the charms bar displays one or more executable applications and the applications bar displays one or more applications that are open on the virtual desktop. The input device can control a cursor on a screen, where a pressing and holding the control button and moving the input device in a first direction causes the charms bar to open, and pressing and holding the control button and moving the input device in a second direction causes the application bar to open. In some embodiments, releasing the control button performs a button press command (e.g., left click make and break command) and operates to select any charm or application that is under the cursor when the button is released. In other embodiments, holding the control button and clicking another input button (e.g., left mouse button) selects the designated charm. In some cases, when a side panel is opened and a left click is performed on a desktop tile or icon (other than the charms), the effect of the single left click is to hide the side panel without selecting the icon/tile.

FIG. 1 is a simplified schematic diagram of a computer system 100 according to an embodiment of the present invention. Computer system 100 includes computer 110, monitor 120, keyboard 130, and input device 140. In one embodiment, input device 140 can be a computer mouse, a remote control device, a game controller, a trackball, a track pad, a touch sensitive device (e.g., tablet computer, personal digital assistant, media player, etc.), a mobile device, or any other suitable device that can be used to convert analog input signals into digital signals for computer processing. For computer system 100, input device 140 and the keyboard can be configured to control various aspects of computer 110 and monitor 120.

In certain embodiments, input device 140 includes a left button 142, a right button 144, a scroll wheel 146, and a control button 148. Control button 148 can be configured to operate the application bar features described herein. Some implementations may include more or less features than shown on input device 140. For example, a computer mouse may only have one button, no scroll wheel, and the control button. Other embodiments may have multiple buttons for performing different functions. Control button 148 can be implemented in any suitable form including, but not limited to, mechanically-based buttons, piezo-electric-based buttons, capacitive-based buttons, resistive-based buttons, touch sensor technologies, or the like. Input device 140. In some cases, input device 140 may include processors, hardware, firmware, software, memory, etc., as further discussed with respect to FIG. 2.

In some embodiments, input device 140 can be configured to provide control signals for movement tracking (e.g., x-y movement on a planar surface, lift detection, etc.), touch/gesture detection, orientation detection, power management methods, desktop side bar control, which is further discussed below, and a host of additional features that would be appreciated by one of ordinary skill in the art with the benefit of this disclosure. Computer 110 may include a machine readable medium (not shown) that is configured to store computer code, such as mouse driver software, keyboard driver software, and the like, where the computer code is executable by a processor (not shown) of the computer 110 to affect control of the computer 110 by input device 140 and keyboard 130. The various embodiments described herein generally refer to input device 140 as a computer mouse or similar input device, however it should be understood that input device 140 can be any input/output (I/O) device, user interface device, control device, input unit, or the like.

In some embodiments, monitor 120 can be any suitable display (e.g., LED, OLED, LCD LED, CRT, etc.) that can be configured to display a virtual desktop environment operated by computer 110. Although most of the embodiments described herein discuss the activation of side bars on a virtual desktop environment, those of ordinary skill in the art will appreciate the many alternative uses (e.g., side panels in games, spreadsheets, word processors, applications, etc.) and digital environments that the foregoing embodiments can apply to.

FIG. 2 is a simplified block diagram of a system 200 configured to operate input device 140, according to an embodiment of the invention. System 200 includes processor(s) 210, sidebar control system 220, movement tracking system 230, power management system 240, communication system 250, and touch detection system 260. Each of the system blocks 220-260 can be in electrical communication with the processor(s) 210. System 200 may further include additional systems that are not shown or discussed to prevent obfuscation of the novel features described herein. System 200 can also include fewer features and may not include touch detections system 260, power management system 240, aspects of communications system 250, and the like.

In certain embodiments, processor(s) 210 can include one or more microprocessors (μCs) and can be configured to control the operation of system 200. Alternatively, processor(s) 210 may include one or more microcontrollers (MCUs), digital signal processors (DSPs), or the like, with supporting hardware and/or firmware (e.g., memory, programmable I/Os, etc.), as would be appreciated by one of ordinary skill in the art with the benefit of this disclosure. Alternatively, MCUs, μCs, DSPs, and the like, may be configured in other system blocks of system 200. For example, sidebar control 220 may include a local processor or firmware to control the sidebar functions described. In some embodiments, multiple processors may provide an increased performance in system 200 speed and bandwidth. It should be noted that although multiple processors may improve system 200 performance, they are not required for standard operation of the embodiments described herein.

Movement tracking system 230 can be configured to track a movement of input device 140, according to certain embodiments of the invention. Movement tracking system 240 can use, e.g., optical sensors such as light-emitting diodes (LEDs) or an imaging array of photodiodes to detect a movement of input device 140 relative to an underlying surface. Input device 140 may optionally comprise movement tracking hardware that utilizes coherent (laser) light. In certain embodiments, one or more optical sensors are disposed on the bottom side of input device 140 (not shown). Movement tracking system 230 can provide positional data (e.g., X-Y coordinate data) or lift detection data. For example, an optical sensor can be used to determine when a user lifts input device 140 off of a surface and send that data to processor(s) 210 for further processing.

In certain embodiments, accelerometers can be used for movement detection. Accelerometers can be electromechanical devices (e.g., micro-electromechanical systems (MEMS) devices) configured to measure acceleration forces (e.g., static and dynamic forces). One or more accelerometers can be used to detect three dimensional (3D) positioning. For example, 3D tracking can utilize a three-axis accelerometer or two two-axis accelerometers. Accelerometers can further determine if input device 140 has been lifted off of a surface and provide movement data that can include the velocity, physical orientation, and acceleration of input device 140. In some embodiments, gyroscope(s) can be used in lieu of or in conjunction with accelerometer(s) to determine movement or input device orientation.

Power management system 240 can be configured to manage power distribution, recharging, power efficiency, and the like, for input device 140. In some embodiments, power management system 240 can include a battery (not shown), a USB based recharging system for the battery (not shown), power management devices (e.g., low-dropout voltage regulators—not shown), and a power grid within system 200 to provide power to each subsystem (e.g., accelerometers 220, gyroscopes 230, etc.). In certain embodiments, the functions provided by power management system 240 may be incorporated into the processor(s) 210.

Communications system 250 can be configured to enable wireless communication between input device 140 and computer 110, or other devices and/or peripherals, according to certain embodiment of the invention. Communications system 250 can be configured to provide radio-frequency (RF), Bluetooth, infra-red, or other suitable communication technology to communicate with other wireless devices. System 200 may optionally comprise a hardwired connection to computer 110. For example, input device 140 can be configured to receive a Universal Serial Bus (USB) cable (or variants) to enable bi-directional electronic communication with computer 110 or other external devices. Some embodiments may utilize different types of cables or connection protocol standards to establish hardwired communication with other entities.

In some embodiments, touch detection system 260 can be configured to detect a touch or touch gesture on one or more touch sensitive surfaces on input device 140. Touch detection system 260 can include one or more touch sensitive surfaces or touch sensors. Touch sensors generally comprise sensing elements suitable to detect a signal such as direct contact, electromagnetic or electrostatic fields, or a beam of electromagnetic radiation. Touch sensors can be configured to detect changes in the received signal, the presence of a signal, the absence of a signal, or a hybrid thereof. Furthermore, a touch sensor may include a source for emitting the detected signal, or the signal may be generated by a secondary source. Touch sensors may be configured to detect the presence of an object at a distance from a reference zone or point, contact with a reference zone or point, or a combination thereof. Certain embodiments of input device 140 may not utilize touch detection or touch sensing capabilities.

Various technologies can be used for touch and/or proximity sensing. Examples of such technologies include, but are not limited to, resistive (e.g., standard air-gap 4-wire based, based on carbon loaded plastics which have different electrical characteristics depending on the pressure (FSR), interpolated FSR, etc.), capacitive (e.g., surface capacitance, self-capacitance, mutual capacitance, etc.), optical (e.g., infrared light barriers matrix, laser based diode coupled with photo-detectors that could measure the time of flight of the light path, etc.), acoustic (e.g., piezo-buzzer coupled with some microphones to detect the modification of the wave propagation pattern related to touch points, etc.), etc.

Although certain necessary systems may not expressly discussed, they should be considered as part of system 200, as would be understood by one of ordinary skill in the art. For example, system 200 may include a bus system to transfer power and/or data to and from the different systems therein. In some embodiments, system 200 may include a storage subsystem (not shown). A storage subsystem can store one or more software programs to be executed by processors (e.g., in processor(s) 210). It should be understood that “software” can refer to sequences of instructions that, when executed by processing unit(s) (e.g., processors, processing devices, etc.), cause system 200 to perform certain operations of software programs. The instructions can be stored as firmware residing in read only memory (ROM) and/or applications stored in media storage that can be read into memory for processing by processing devices. Software can be implemented as a single program or a collection of separate programs and can be stored in non-volatile storage and copied in whole or in-part to volatile working memory during program execution. From a storage subsystem, processing devices can retrieve program instructions to execute in order to execute various operations (e.g., open desktop sidebars) as described herein.

It should be appreciated that system 200 is illustrative and that variations and modifications are possible. System 200 can have other capabilities not specifically described here (e.g., mobile phone, global positioning system (GPS), power management, one or more cameras, various connection ports for connecting external devices or accessories, etc.). Further, while system 200 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatuses including electronic devices implemented using any combination of circuitry and software. Furthermore, aspects and/or portions of system 200 may be combined with or operated by other sub-systems as required by design. For example, sidebar control 220 may operate within processor(s) 210 instead of functioning as a separate entity. Moreover, it should be understood that the various embodiments of conformable regions discussed herein can be of any size, shape, color, texture, etc., and can be applied to any input device (e.g., input device 140), with any suitable control infrastructure (e.g., system 200 including combinations and subsets thereof), at any preferred location and in any desired configuration.

FIG. 3 is a simplified flow diagram illustrating a method 300 for activating a side bar on a virtual desktop, according to certain embodiments of the invention. Method 300 is performed by processing logic that may comprise hardware (circuitry, dedicated logic, etc.), software (such as is run on a general purpose computing system or a dedicated machine), firmware (embedded software), or any combination thereof. In one embodiment, method 300 is performed by processor(s) 210 of FIG. 2.

Referring to FIG. 3, method 300 beings with receiving a first input signal indicating a button press on an input device (310). In some aspects, the first input signal can be generated by control button 148 of input device 140, shown in FIG. 1. The first input signal can be generated or transmitted to processor 210 in any suitable fashion. For example, control button 148 can be implemented in any suitable form including, but not limited to, mechanically-based buttons, piezo-electric-based buttons, capacitive-based buttons, resistive-based buttons, touch sensor technologies, or the like. Control button 148 can be one button, multiple buttons, a switch, lever, or any configuration that can provide an electrical signal indicating actuation (i.e., a button press).

At 320, processor 210 receives a second input signal corresponding to a movement of a cursor on a display (e.g., a virtual desktop). In some embodiments, the second input signal can be provided by movement tracking system 230 of system 200. The second input signal is typically positional data (e.g., X-Y coordinate tracking data) indicating a rate and direction of movement of the input device. Referring back to 320, the second input signal indicates a movement in the direction of the location of the first side panel. In some embodiments, the first side panel is located on the right hand edge of the display. For example, in Windows 8™, a “charms” bar opens on the right side of the Windows™ desktop and “hides” or slides out of view when not in use. Thus, in a particular embodiment, the second input signal indicates a movement of the input device toward the right hand side of the display towards the location of the first sidebar. At 330, method 300 further includes sending a command (e.g., to the computer hosting the desktop environment) to open the first side panel in response to receiving the first input signal and the second input signal indicating a movement toward the first side panel. In summary, the first side panel is opened in response to receiving an indication of a button press (i.e., first input signal) on the control button and an indication of movement toward the first side panel (i.e., second input signal).

At 340, processor 210 receives the second input signal corresponding to a movement of the cursor on a display (e.g., virtual desktop), and more particularly, in the direction of a second side panel. In some embodiments, the second side panel is located on the left hand edge of the display. For example, in Windows 8™, an “applications” bar opens on the left side of the Windows™ desktop and “hides” or slides out of view when not in use. At 350, method 300 further includes sending a command to open the second side panel in response to receiving the first input signal and the second input signal indicating a movement toward the first side panel. Thus, in a particular embodiment, when the second input signal indicates a movement of the input device toward the left hand side of the display—that is, towards the location of the second sidebar, the second sidebar panel is opened and the left sidebar panel is closed. In summary, the second side panel is opened in response to receiving an indication of a button press (i.e., first input signal) on the control button and an indication of movement toward the second side panel (i.e., second input signal).

As discussed above, the first side panel can be populated with a first set of one or more selectable icons for launching executable files. For example, these icons for launching executable files or “charms” can include commonly used programs. The icons can be presented in any suitable format, font, or presentation corresponding to the sidebar. Similarly, the second side panel can be populated with a second set of one or more selectable icons for moving currently running applications to a foreground on the virtual desktop. For example, a user may have multiple applications open at once and can use this particular side bar to cycle or select between currently running applications. It should be understood that sidebars can be configured to be located anywhere, in any direction, and can be populated with any suitable content. This is typically dictated by the software running the virtual desktop environment. The embodiments described herein can be adapted to any such implementation, as would be appreciated by one of ordinary skill in the art.

At 360, processor 210 receives an indication of a selection of a selectable icon in response to a subsequent button press or a button release. The indication of selection can include receiving the second input signal indicating movement and positioning of the cursor over a selectable icon and receiving the first input signal indicating a button press. In a non-limiting example, when a user positions a cursor over a selectable icon (e.g., presses control button, moves cursor to the second side to open second side bar, and positions cursor over selectable icon), the selectable icon can be selected by releasing the control button. In some embodiments, the selectable icon can be selected by pressing and releasing the control button again when the cursor is positioned over the desired selectable icon.

It should be appreciated that the specific steps illustrated in FIG. 3 provide a particular method of activating a sidebar on a virtual desktop, according to certain embodiments of the present invention. Other sequences of steps may also be performed according in alternative embodiments. For example, alternative embodiments of the present invention may perform the steps outlined above in a different order. To illustrate, a user may only open one side bar without activating the second, or vice versa. Moreover, the individual steps illustrated in FIG. 3 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 300.

FIG. 4 is a simplified flow diagram illustrating a method 400 for activating a side bar on a virtual desktop, according to certain embodiments of the invention. Method 400 is performed by processing logic that may comprise hardware (circuitry, dedicated logic, etc.), software (such as is run on a general purpose computing system or a dedicated machine), firmware (embedded software), or any combination thereof. In one embodiment, method 400 is performed by processor(s) 210 of FIG. 2.

Referring to FIG. 4, method 400 begins with receiving a first input signal indicating a button press on an input device (410). In some aspects, the first input signal can be generated by control button 148 of input device 140, shown in FIG. 1. The first input signal can be generated or transmitted to processor 210 in any suitable fashion. For example, control button 148 can be implemented in any suitable form including, but not limited to, mechanically-based buttons, piezo-electric-based buttons, capacitive-based buttons, resistive-based buttons, touch sensor technologies, or the like. Control button 148 can be one button, multiple buttons, a switch, lever, or any configuration that can provide an electrical signal indicating actuation (i.e., a button press).

At 420, method 400 proceeds with opening the first side panel in response to receiving the first input signal. In summary, the first side panel is opened in response to receiving an indication of a button press (i.e., first input signal) on the control button. This is in contrast to the operation 330 of method 300 which requires a movement signal to determine which side bar to open up in addition to the first input signal (i.e., control button press). In this particular embodiment, pressing the control button alone opens the first side bar.

At 430, processor 210 receives the second input signal corresponding to a movement of the cursor on a display (e.g., virtual desktop), and more particularly, in the direction of a second side panel. In some embodiments, the second side panel is located on the left hand edge of the display, however any edge, portion of an edge, corner, or the like are possible. In one non-limiting example, Windows 8™ includes an “applications” bar that opens on the left side of the desktop and “hides” or slides out of view when not in use.

At 440, method 400 proceeds with opening the second side panel in response to receiving the first input signal and the second input signal indicating a movement toward the second side panel. In summary, the second side panel is opened in response to receiving an indication of a button press (i.e., first input signal) on the control button and an indication of movement toward the second side panel (i.e., second input signal). In some embodiments, the first side panel is closed as the second side panel is opened, and vice versa.

As discussed above with respect to method 300, the first and second side panels can be populated with a first set of one or more selectable icons for launching executable files. For example, these icons for launching executable files or “charms” or currently running applications. The icons can be presented in any suitable format, font, or presentation corresponding to the sidebar. It should be understood that sidebars can be configured to be located anywhere, in any direction or configuration, and can be populated with any suitable content. This is typically dictated by the software running the virtual desktop environment. The embodiments described herein can be adapted to any such implementation, as would be appreciated by one of ordinary skill in the art.

At 450, processor 210 receives an indication of a selection of a selectable icon in response to a subsequent button press or a button release. The indication of selection can include receiving the second input signal indicating movement and positioning of the cursor over a selectable icon and receiving the first input signal indicating a button press. In a non-limiting example, when a user positions a cursor over a selectable icon (e.g., presses control button, moves cursor to the second side to open second side bar, and positions cursor over selectable icon), the selectable icon can be selected by releasing the control button. In some embodiments, the selectable icon can be selected by pressing and releasing the control button again when the cursor is positioned over the desired selectable icon.

It should be appreciated that the specific steps illustrated in FIG. 4 provide a particular method of activating a sidebar on a virtual desktop, according to certain embodiments of the present invention. Other sequences of steps may also be performed according in alternative embodiments. For example, alternative embodiments of the present invention may perform the steps outlined above in a different order. To illustrate, a user may only open one side bar without activating the second, or vice versa. Moreover, the individual steps illustrated in FIG. 4 may include multiple sub-steps that may be performed in various sequences as appropriate to the individual step. Furthermore, additional steps may be added or removed depending on the particular applications. One of ordinary skill in the art would recognize and appreciate many variations, modifications, and alternatives of the method 400.

FIG. 5 is a simplified state chart 500 illustrating operations including the activation of a sidebar on a virtual desktop, according to certain embodiments of the invention. State chart 500 is performed by processing logic that may comprise hardware (circuitry, dedicated logic, etc.), software (such as is run on a general purpose computing system or a dedicated machine), firmware (embedded software), or any combination thereof. In one embodiment, state chart 500 is performed by aspects of system 200 of FIG. 2.

Referring to FIG. 5, for the purposes of understanding and interpreting state chart 500, arrows shown originating from a solid circle specifies the default state when the system first begins. In a composite state (e.g., state w8_button_pressed above), the local initial transition specifies the default substate (moving_right in this case) that can be immediately entered when its superstate (w8_button_pressed) is the target state of a transition, such as “button press” in this particular case. Furthermore, each state may have entry or exit actions, and each transition may have a trigger and an action associated with it.

At state 510, an initial transition to state 515 begins with the control button of input device 140 in a released or “unpressed” state. At state 520, the control button is pressed, which corresponds to the first input signal of methods 200 and 300. While in the pressed state 525, as the input device 140 is moved toward the right (530), the right side panel is opened (550). Alternatively, while in the pressed state 525, as the input device 140 is moved toward the left (540), the left side panel is opened (560). In certain embodiments, the right side panel can be a “charms” bar including one or more selectable icons for opening executable files. The left side panel can be an “application bar” populated with icons for each application currently running on an operating system. Selecting an application can bring the selected running application into the foreground in a virtual desktop environment.

At state 570, the control button is released. If the cursor is positioned over one of the selectable icons in any side bar, then a “left click” signal or “makebreak” signal is sent, which can be equivalent to a standard left click signal from an input device such as a computer mouse. If the cursor is positioned any place on the virtual desktop (or other application or platform) other than where the side bars are located when the button is released, the side bars are closed and the system returns to a default initial state (e.g., no activity).

FIG. 6 is a simplified state chart illustrating operations including the activation of a sidebar on a virtual desktop, according to certain embodiments of the invention. State chart 600 is performed by processing logic that may comprise hardware (circuitry, dedicated logic, etc.), software (such as is run on a general purpose computing system or a dedicated machine), firmware (embedded software), or any combination thereof. In one embodiment, state chart 600 is performed by aspects of system 200 of FIG. 2.

For the sake of clarity, “hid_button” can be a standard button (e.g., left mouse button 142), and “w8_charms” can be a control button (e.g., button 148). Other configurations of buttons, function assignments, and the like, can be applied to the foregoing concepts, as would be appreciated by one of ordinary skill in the art.

At state 605, an initial transition to an idle state 610 occurs. The idle state 610 is maintained as button 142 is pressed (625) and released (615). Idle state 610 is also maintained if the control button 148 is pressed and released without movement (e.g., no cursor movement). If the control button 148 is pressed (640) and held (active—645), and the input device 140 is moved to the right (650), a command is sent by processor 210 to computer 110 to open a right side panel (660). If the control button 148 is pressed (640) and held (active—645), and the input device 140 is moved to the left (665), a command is sent by processor 210 to computer 110 to open a left side panel (675). In certain embodiments, the right side panel can be a “charms” bar including one or more selectable icons for opening executable files. The left side panel can be an “application bar” populated with icons for each application currently running on an operating system. Selecting an application can bring the selected running application into the foreground in a virtual desktop environment.

At state 680, the control button is released and a left click or “makebreak” signal is sent. In other words, in this particular embodiment, instead of using two buttons to select a charm (i.e., control button 148 to open side panel and left button 142 to make the selection), only the control button is required to make the selection. In other words, a user can hold down control button 148, open the desired side panel by moving the input device in the appropriate direction, and then select a desired charm (e.g., application or executable file) by releasing control button 148 while positioned over the particular charm. The system then returns to the idle state 610.

Additional Functions and Advantages

The embodiments described herein do not require software to perform basic side panel operations. However, software can enhance the user experience by adding additional functionality and customization schemes. Some exemplary enhancements include options to remap the buttons and/or gestures associated with a particular input device, provide feedback if a user wants to see the application switch panel, but no applications are currently open, the control button function can be assigned to other buttons on the input device, and more. With software, some embodiments can be configured such that side panels are not immediately triggered and an on-screen overlay invites the user to move the mouse left or right. Many other customizations are possible, which can be applied to any number of side bars present in a particular embodiment.

In contemporary applications that use left and right side panels (e.g., Microsoft Windows 8), the left and right panels are designed to be used with direct touch devices (e.g., touch screens and indirect touch devices (e.g., touch pads) by means of the Microsoft defined “edge gestures.” These edge gestures start by moving the pointing device (e.g., finger or stylus) from the outside to the interior of the touch device. The embodiments described herein that use an input device to launch a side panel invert this paradigm. In other words, the input device (e.g., mouse) moves from the interior to the outside of the screen. For example, a user may have a cursor positioned in the center of the screen. In order to activate the left side panel, the user presses the control button and moves the mouse towards the side bar. Thus, the same movement that triggers the edge/side panel(s), moves the screen cursor to its target, which further optimizes the user effort. This further applies to top/bottom side panels and/or corner panels.

From an indirect pointing perspective (e.g., mouse/track pad user), the use of “hot corners” to allow access to important and frequently used functionality on a conventional GUI is motivated by the fact that these corners are easy to reach according to Fitts' Law, since the target has theoretically infinite size, i.e., you can move the cursor to the corner with requiring a precise target selection. For example, in Windows 8 (or any GUI with side bars), the operation typically occurs in two stages: a user moves the cursor to a corner, causing the functionality (side panel) to be revealed and available for user interaction. The user then moves from the corner down to the desired application (“charm”) and makes the selection.

In contrast, the embodiments described herein allow a user to access the revealed functionality without the required move to the hot corner. By removing the step to target the corner it essentially shortens the operation, which can be an appreciable amount of time when taken in the aggregate over the course of a work day. There is also the advantage that the control options are revealed quicker, so that the user can see the available options during the move. That is, by having the options revealed earlier, the method improves both the movement time and selection time.

It is also understood that the examples and embodiments described herein are for illustrative purposes only and that various modifications or changes in light thereof will be suggested to persons skilled in the art and are to be included within the spirit and purview of this application and scope of the appended claims.

It should be noted that certain embodiments of the present invention can perform some or all of the functions described herein. For example, some embodiments can perform all of the functions described in FIGS. 3-6, while others may be limited to specific functions.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network. However, as stated above, the functionality regarding the opening/closing of sidebars and making selections thereon can be implemented in firmware, hardware, and combinations thereof, and do not require software to generate the control signals that perform basic sidebar controls.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

In embodiments, any of the entities described herein may be embodied by a computer that performs any or all of the functions and steps disclosed.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. An input device comprising:
a processor;
a displacement sensor coupled to the processor and configured to detect movement of the input device relative to a surface; and
a control button coupled to and controlled by the processor, the control button configured to send a command to open a first side panel on a virtual desktop of an operating system.

2. The input device of claim 1 further configured to send a command to open a second side panel on the virtual desktop, wherein the first side panel is opened when the control button is pressed, and the second side panel is opened when the control button is pressed and the input device is moved in the direction of the second side panel.

3. The input device of claim 1 further configured to send a command to open a second side panel on the virtual desktop, wherein the first side panel is opened when the control button is pressed and the input device is moved in a direction of the first side panel, and wherein the second side panel is opened when the control button is pressed and the input device is moved in a direction of the second side panel.

4. The input device of claim 2 wherein the first side panel is populated with a first set of one or more selectable icons for launching executable files, and wherein the second side panel is populated with a second set of one or more selectable icons for moving currently running applications to a foreground on the virtual desktop.

5. The input device of claim 2 further configured to open a third side panel and a fourth side panel on the virtual desktop, wherein the third side panel is opened when the control button is pressed and the input device is moved in a direction of the third side panel, and wherein the fourth side panel is opened when the control button is pressed and the input device is moved in a direction of the fourth side panel.

6. The input device of claim 4 further configured to control a cursor on the virtual desktop, wherein the control button is configured to send a command to open the first side panel on the virtual desktop when the control button is pressed and held, and wherein each of the selectable icons is operable to be selected in response to the control button being released when the cursor is placed over the particular selectable icon.

7. The input device of claim 4 further configured to control a cursor on the virtual desktop, wherein each of the selectable icons is operable to be selected in response to the control button being pressed when the cursor is placed over the particular selectable icon.

8. The input device of claim 2 wherein the first side panel is configured to close and the second side panel is configured to open in response to the control button still being pressed and the input device being moved in the direction of the second side panel by a predetermined displacement, and wherein the first side panel is configured to close and the second side panel is configured to open in response to the control button still being pressed and the input device being moved in the direction of the second side panel by the predetermined displacement.

9. The input device of claim 2 further comprising an input button, wherein the first and second side panels are closed when the input button or the control button are pressed in areas outside of the first or second side panels.

10. The input device of claim 1 wherein the control button is one of a mechanical, piezo-electric, or touch sensor based button.

11. A method comprising:
receiving a first input signal indicating a button press on an input device;
receiving a second input signal corresponding to a movement of a cursor on a virtual desktop, wherein the cursor is controlled by the input device; and
sending a command to open a first side panel on the virtual desktop in response to receiving the first input signal and the second input signal when the second input signal indicates cursor movement in the direction of the first side panel.

12. The method of claim 11 further comprising:
sending a command to open a second side panel on the virtual desktop in response to receiving the first input signal and the second input signal when the second input signal indicates cursor movement in the direction of the second side panel.

13. The method of claim 12 further comprising:
sending a command to open a third side panel on the virtual desktop in response to receiving the first input signal and the second input signal when the second input signal indicates cursor movement in the direction of the third side panel; and
sending a command to open a fourth side panel on the virtual desktop in response to receiving the first input signal and the second input signal when the second input signal indicates cursor movement in the direction of the fourth side panel.

14. The method of claim 12 wherein the first side panel is populated with a first set of one or more selectable icons for launching executable files, and wherein the second side panel is populated with a second set of one or more selectable icons for moving currently running applications to a foreground on the virtual desktop.

15. The method of claim 14 further comprising:
receiving the second input signal indicating movement and positioning of the cursor over a selectable icon;
receiving the first input signal indicating a button press;
sending a command to select the selectable icon that the cursor is positioned over.

16. A system comprising:
one or more processors;
one or more non-transitory computer-readable storage mediums containing instructions configured to cause the one or more processors to perform operations including:
receiving a first input signal indicating a button press on an input device;
receiving a second input signal corresponding to a movement of a cursor on a virtual desktop, wherein the cursor is controlled by the input device; and
sending a command to open a first side panel on the virtual desktop in response to receiving the first input signal and the second input signal when the second input signal indicates cursor movement in the direction of the first side panel.

17. The system of claim 16 further comprising instructions configured to cause the one or more processors to perform operations including:
sending a command to open a second side panel on the virtual desktop in response to receiving the first input signal and the second input signal when the second input signal indicates cursor movement in the direction of the second side panel.

18. The system of claim 17 further comprising instructions configured to cause the one or more processors to perform operations including:
sending a command to open a third side panel on the virtual desktop in response to receiving the first input signal and the second input signal when the second input signal indicates cursor movement in the direction of the third side panel; and
sending a command to open a fourth side panel on the virtual desktop in response to receiving the first input signal and the second input signal when the second input signal indicates cursor movement in the direction of the fourth side panel.

19. The system of claim 17 wherein the first side panel is populated with a first set of one or more selectable icons for launching executable files, and wherein the second side panel is populated with a second set of one or more selectable icons for moving currently running applications to a foreground on the virtual desktop.

20. The system of claim 19 further comprising instructions configured to cause the one or more processors to perform operations including:
receiving the second input signal indicating movement and positioning of the cursor over a selectable icon;
receiving the first input signal indicating a button press;
sending a command to select the selectable icon that the cursor is positioned over.
